(19) United States
(12) Patent Application Publication
(10) Pub. No.: US 2026/0283353 A1
(43) Pub. Date: Sep. 24, 2026

(54) SLIDING RAIL DEVICE

(71) Applicant: FOSITEK CORPORATION, New Taipei City (TW)

(72) Inventors: Hsu-Hong YAO, New Taipei City (TW); Hsuan-Po HUANG, New Taipei City (TW); Jian-Bo LIAO, New Taipei City (TW)

(73) Assignee: FOSITEK CORPORATION, New Taipei City (TW)

(21) Appl. No.: 19/241,665

(22) Filed: Jun. 18, 2025

(30) Foreign Application Priority Data
Mar. 21, 2025 (TW) 114110701

(51) Int. Cl. A47B 88/487; A47B 88/497; F16C 29/04

(52) U.S. Cl. CPC A47B 88/487; A47B 88/497; F16C 29/046; F16C 2314/72

(57) ABSTRACT

A sliding rail device includes a first rail unit and a second rail. The first rail unit includes a first rail, and a slider member movably engaged with the first rail. The second rail is movably engaged with the first rail, and includes a driver block extending towards the first rail. The second rail is movable relative to the first rail in a sliding direction to abut the driver block against the slider member, and is further movable in the sliding direction to drive the slider member to move in the sliding direction relative to the first rail.

### CROSS-REFERENCE TO RELATED APPLICATION

This application claims priority to Taiwanese Invention Patent Application No. 114110701, filed on Mar. 21, 2025, the entire disclosure of which is incorporated by reference herein.

### FIELD

The disclosure relates to a sliding rail device, and more particularly to a sliding rail device adapted for mounting with a chassis.

### BACKGROUND

A conventional sliding rail includes an inner rail, an intermediate rail, and a slider device disposed between the inner rail and the intermediate rail. The inner rail can be moved to pass through an end of the intermediate rail for disengagement, so that a chassis can be mounted to the inner rail after the inner rail is disengaged from the intermediate rail. However, the conventional sliding rail does not have a mechanism or structure which ensures that, when the inner rail is moved towards the end of the intermediate rail, the slider device moves with the inner rail. If, after the chassis is mounted to the inner rail, the inner rail is reinstalled to the intermediate rail while the slider device is away from the end of the intermediate rail, the engagement between the inner rail and the slider device will be loose or misaligned, which may lead to deformation of the slider device or the inner rail, thereby causing safety problems during installation of the chassis. Hence, there is room for improvement.

### SUMMARY

Therefore, an object of the disclosure is to provide a sliding rail device that can alleviate at least one of the drawbacks of the prior art.

According to the disclosure, the sliding rail device includes a first rail unit and a second rail. The first rail unit includes a first rail, and a slider member movably engaged with the first rail. The second rail is movably engaged with the first rail, and includes a driver block extending towards the first rail. The second rail is movable relative to the first rail in a sliding direction to abut the driver block against the slider member, and is further movable in the sliding direction to drive the slider member to move in the sliding direction relative to the first rail.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an embodiment of a sliding rail device according to the disclosure.

FIG. 2 is a partially exploded perspective view of the embodiment.

FIG. 3 is a fragmentary perspective view of a first rail unit of the embodiment.

FIG. 4 is a fragmentary perspective view of a slider member of the embodiment.

FIG. 5 is a side view of a second rail of the embodiment.

FIG. 6 is a fragmentary side view of the embodiment.

FIG. 7 is a partially enlarged view of FIG. 6.

FIG. 8 is another fragmentary side view of the embodiment, illustrating a driver block abutting against a resilient plate.

FIG. 9 is a partially enlarged view of FIG. 8.

FIG. 10 is another fragmentary side view of the embodiment, illustrating the slider member in a disengaging position.

FIG. 11 is a partially enlarged view of FIG. 10.

FIG. 12 is a fragmentary sectional view of the embodiment taken along line XII-XII in FIG. 10.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

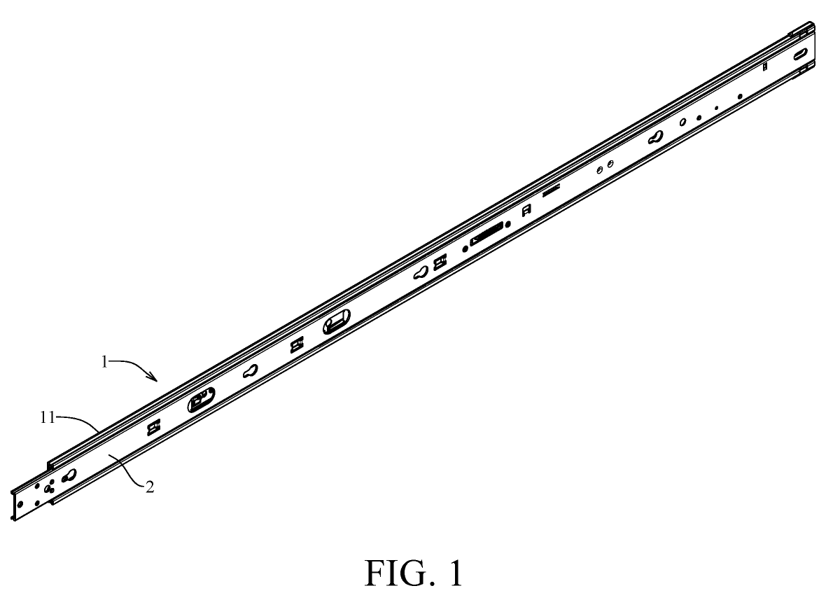

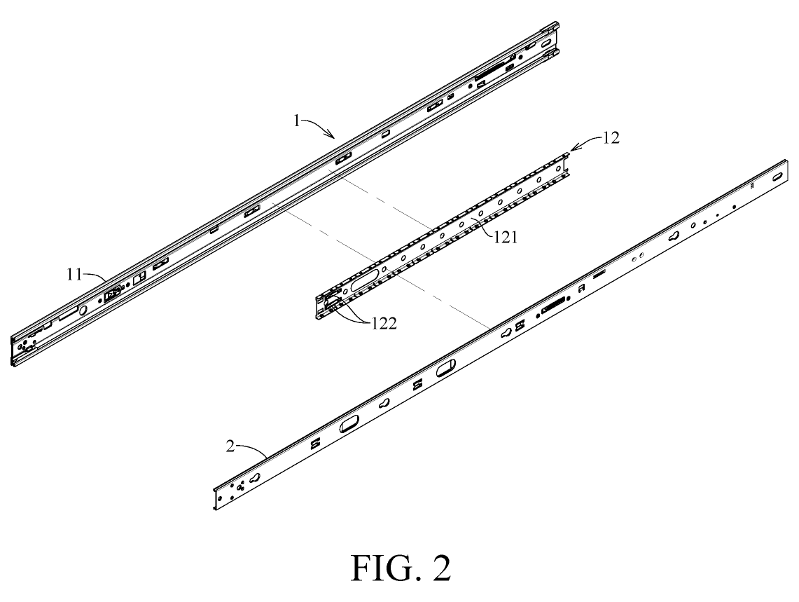

Referring to FIGS. 1 and 2, an embodiment of a sliding rail device according to the disclosure includes a first rail unit 1 and a second rail 2.

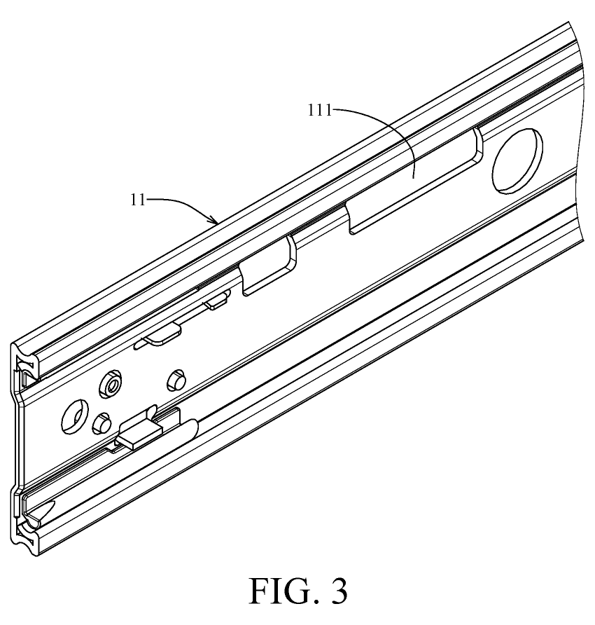

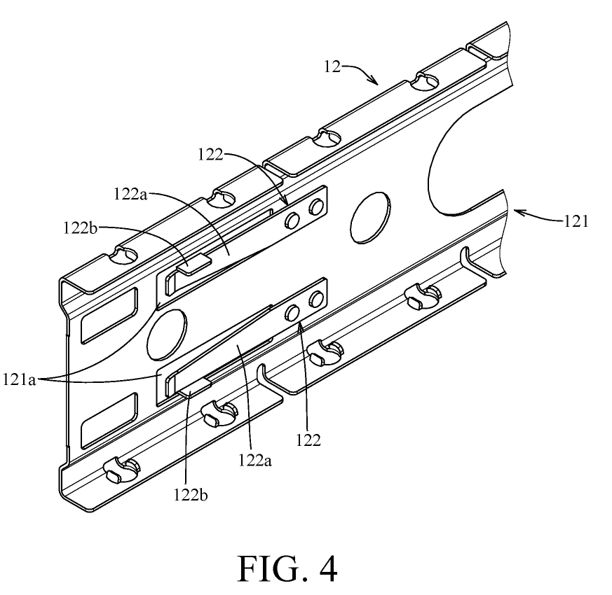

Referring to FIGS. 2 to 4, the first rail unit 1 includes a first rail 11, and a slider member 12 movably engaged with the first rail 11. The first rail 11 is formed with a receiving hole 111 that is proximate to an end of the first rail 11. In this embodiment, the slider member 12 includes a base body 121 that is movably engaged with the first rail 11, and two resilient plates 122 that are disposed on the base body 121. The base body 121 is formed with two through holes 121a. Each of the resilient plates 122 is disposed adjacent to a respective one of the through holes 121a, and has an arm portion 122a that is disposed on the base body 121, and an abutment portion 122b that extends from the arm portion 122a towards the second rail 2. For the sake of brevity, only one of the resilient plates 122 and one of the through holes 121a will be illustrated in the following.

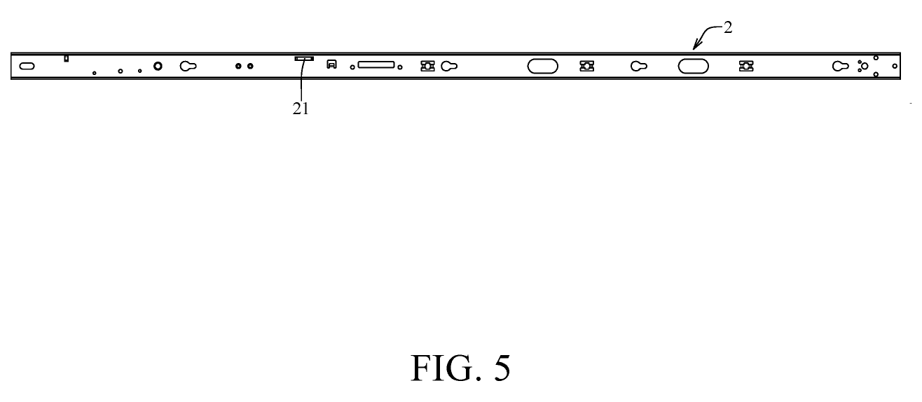

Referring further to FIG. 5, the second rail 2 is adapted for a chassis (not shown) to be mounted thereonto, and is movably engaged with the first rail 11. The slider member 12 makes movement of the second rail 2 relative to the first rail 11 smoother. The second rail 2 includes a driver block 21 extending towards the first rail 11.

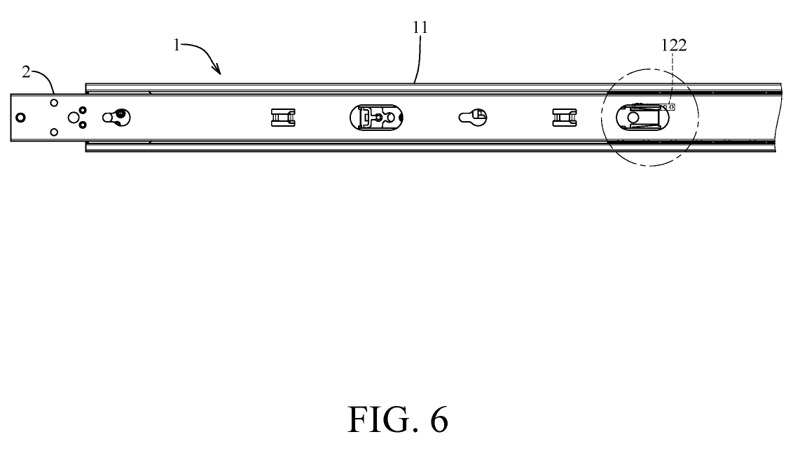

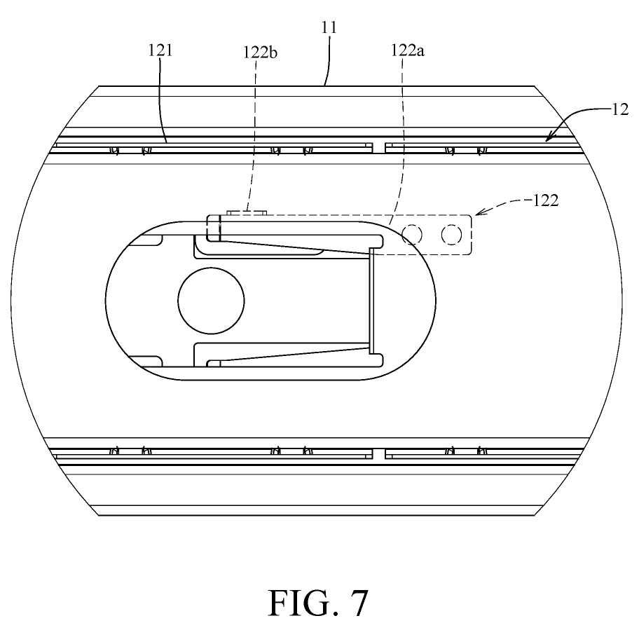

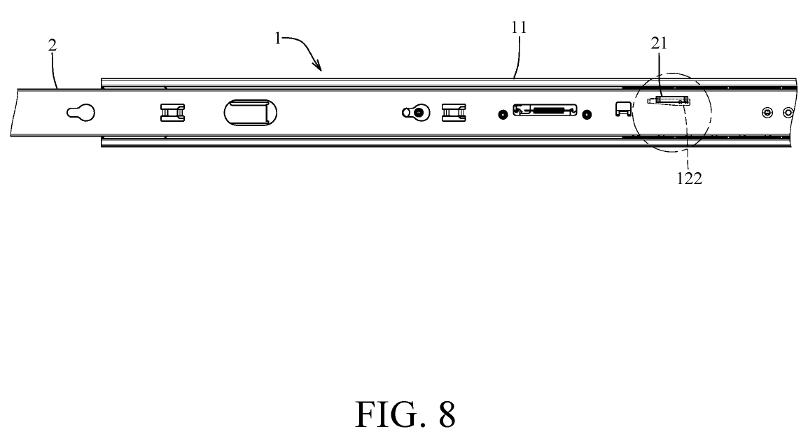

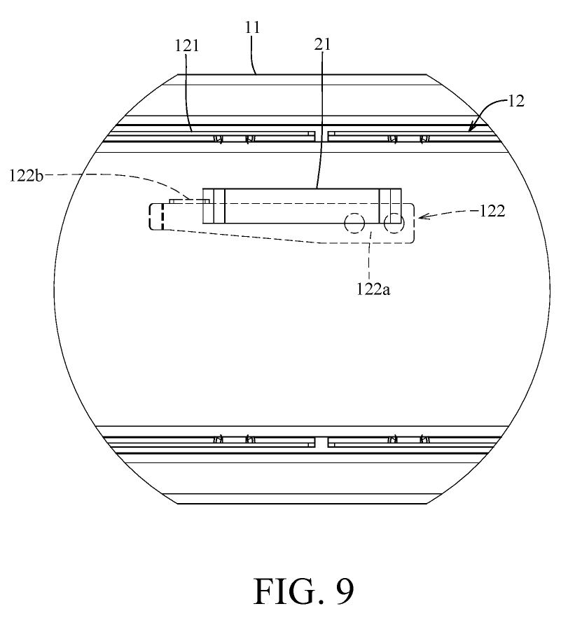

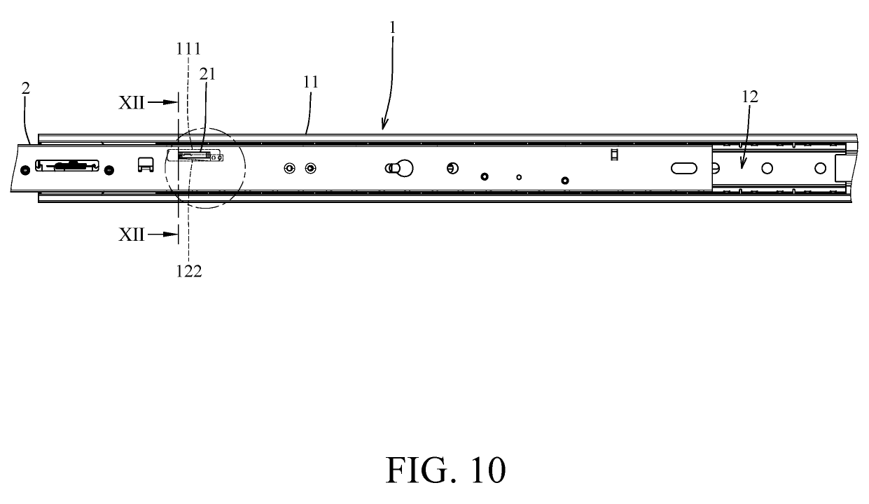

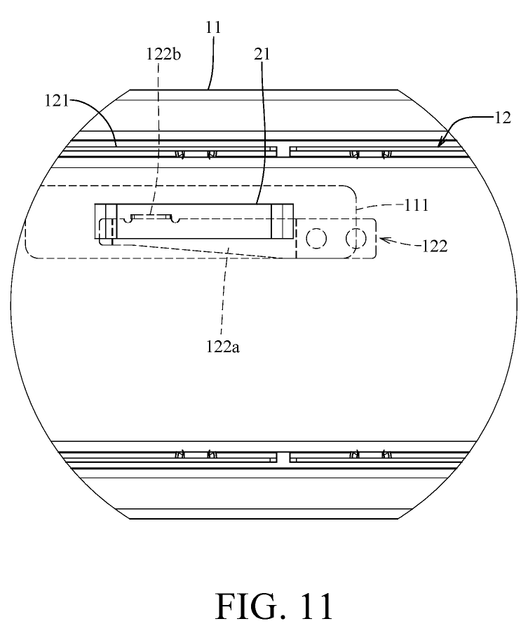

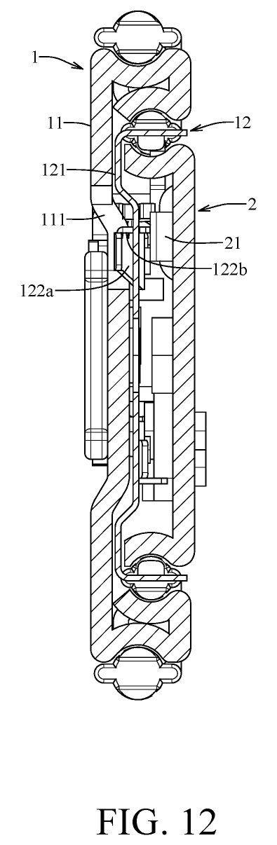

Referring to FIGS. 6 to 9, the second rail 2 is movable relative to the first rail 11 in a sliding direction to abut the driver block 21 against the abutment portion 122b of the resilient plate 122, and is further movable in the sliding direction to drive the slider member 12 to move in the sliding direction relative to the first rail 11 (see FIGS. 8 and 9). When the slider member 12 is driven by the second rail 2 to move in the sliding direction relative to the first rail 11 to a disengaging position (see FIGS. 10 to 12), the driver block 21 drives the abutment portion 122b to deform resiliently and move through the through hole 121a and into the receiving hole 111 such that the second rail 2 is allowed to further move relative to the slider member 12 in the sliding direction relative to the first rail 11 for disengagement from the first rail 11. After the second rail 2 is disengaged from the first rail 11, the chassis may be maintained or changed. Then, the second rail 2 is re-engaged with the first rail 11 while the slider member 12 is in the disengaging position. Hence, the second rail 2 is easily re-engaged with the first rail 11 via the slider member 12 without damaging the slider member 12.

It should be noted that, in this embodiment, the first rail 11 and the second rail 2 are, respectively, an intermediate rail and an inner rail of a sliding rail, but may be other components of a sliding rail in other embodiments. In another embodiment, the first rail 11 and the second rail 2 are, respectively, an outer rail and an intermediate rail of a sliding rail.

In conclusion, the driver block 21 abuts against the resilient plate 122 when the second rail 2 is moved relative to the first rail 11 in the sliding direction, which ensures movement of the slider member 12 when the second rail 2 keeps moving in the sliding direction. Furthermore, after the chassis is mounted to the second rail 2, the second rail 2 can be re-engaged with the first rail 11 when the slider member 12 is in the disengaging positon, which prevents damage caused by misaligned engagement between the second rail 2 and the slider member 12 during installation of the chassis. Hence, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A sliding rail device comprising:
a first rail unit that includes
a first rail, and
a slider member movably engaged with said first rail; and
a second rail that is movably engaged with said first rail, and that includes a driver block extending towards said first rail;
wherein, said second rail is movable relative to said first rail in a sliding direction to abut said driver block against said slider member, and is further movable in the sliding direction to drive said slider member to move in the sliding direction relative to said first rail.

2. The sliding rail device as claimed in claim 1, wherein said slider member includes a base body that is movably engaged with said first rail, and a resilient plate that is disposed on said base body, said second rail being movable relative to said first rail in the sliding direction to abut said driver block against said resilient plate of said slider member.

3. The sliding rail device as claimed in claim 2, wherein said resilient plate has an arm portion that is disposed on said base body, and an abutment portion that extends from said arm portion towards said second rail, said second rail being movable relative to said first rail in the sliding direction to abut said driver block against said abutment portion of said resilient plate of said slider member.

4. The sliding rail device as claimed in claim 3, wherein:
said first rail is formed with a receiving hole, said base body being formed with a through hole; and
when said driver block abuts against said abutment portion of said resilient plate of said slider member, said second rail is movable in the sliding direction to drive said slider member to move in the sliding direction relative to said first rail to a disengaging position where said driver block drives said abutment portion to move through said through hole and into said receiving hole such that said second rail is allowed to further move relative to said slider member in the sliding direction relative to said first rail for disengagement from said first rail.
